(19) United States
(12) Patent Application Publication
(10) Pub. No.: US 2011/0041248 A1
(43) Pub. Date: Feb. 24, 2011

(54) BEDSORE PREVENTION MATTRESS

(76) Inventor: Ju Young KIM, Gyeongsangbuk-do (KR)

Correspondence Address: IPLA P.A., 3550 WILSHIRE BLVD., 17TH FLOOR, LOS ANGELES, CA, 90010, US

(21) Appl. No.: 12/858,784

(22) Filed: Aug. 18, 2010

(30) Foreign Application Priority Data
Aug. 18, 2009 (KR) 10-2009-0076148

(51) Int. Cl. A47C 27/10; A61G 7/02

(52) U.S. Cl. 5/604; 5/713

(57) ABSTRACT

A bedsore prevention mattress is disclosed, which can effectively prevent a bedsore of a patient who uses a bed or the like for a long time by circulating air while raising a portion directly contacting with a back, waist or shoulder of a patient. The bedsore prevention mattress comprises a plurality of air cylinder apparatuses each equipped with a vertically installed cylinder body, a piston rod which is engaged to each cylinder body and moves up and down, and a contact means which is engaged to an upper side of the piston rod and contacts with a patient's back; an air supply apparatus for supplying a high pressure air to each air cylinder apparatus; an air supply tube H which connects each air cylinder apparatus and the air supply apparatus; and a control unit C which controls the operations of the air supply apparatus and the air cylinder apparatus.

### CROSS REFERENCE

This application claims foreign priority under Paris Convention and 35 U.S.C. §119 to Korean Patent Application No. 10-2009-0076148, filed Aug. 18, 2009 with the Korean Intellectual Property Office.

### BACKGROUND OF THE INVENTION

1. Technical Field

The present invention relates to a bedsore prevention mattress, and in particular to a bedsore prevention mattress which can effectively prevent a bedsore of a patient who uses a bed or the like for a long time by circulating air while raising a portion directly contacting with a back, waist or shoulder of a patient.

2. Description of the Related Art

Bedsore generally appears in a weakened patient who uses a bed for a long time and a patient who cannot freely move a posture due to a brain and spinal cord disorder. The bedsore occurs in a body portion in which a body weight concentrates or a body portion protruded by means of a bone. In rare case, a bedsore occurs in a body portion supported by a splint or a pressing portion due to cast.

The pressed skin has a worse blood circulation and turns pale which results in a dark red skin along with a pressure.

When such a symptom advances, blisters are formed and skins turn dark black, and the skin with necrosis is separated, and secretion comes out along with bad smell.

It is very important to prevent the bedsore with the above symptoms. In order to prevent the bedsore, it is needed to change the posture several times a day and bedclothes should be smooth and flexible without treating to be stiff, and blanket for a bedsore patient should be light.

Changing the posture of a patient who cannot move freely needs a very hard work, and in worse situation a woman helper or an old age helper cannot easily change the posture of a patient in order to prevent a bedsore of a patient.

### SUMMARY OF THE INVENTION

Accordingly, it is an object of the present invention to provide a bedsore prevention mattress which overcomes the problems encountered in a conventional mattress.

It is another object of the present invention to provided a bedsore prevention mattress which can efficiently prevent a bedsore of a patient in such a manner that a plurality of support members alternately move up and down toward an upper side of a mattress on which a patient lies unless a patient directly changes a posture for thereby facilitating a good blood circulation of a patient's back portion, and sweat can be efficiently dried by air circulation.

To achieve the above objects, there is provided a bedsore prevention mattress which comprises a plurality of air cylinder apparatuses each equipped with a vertically installed cylinder body, a piston rod which is engaged to each cylinder body and moves up and down, and a contact member which is engaged to an upper side of the piston rod and contacts with a patient's back; an air supply apparatus for supplying a high pressure air to each air cylinder apparatus; an air supply tube H which connects each air cylinder apparatus and the air supply apparatus; and a control unit C which controls the operations of the air supply apparatus and the air cylinder apparatus.

The piston rod of the air cylinder apparatus is formed in a hollow cylindrical shape.

The contact member includes a cap which is engaged to an upper side of the piston rod and is equipped with a plurality of ventilation holes, and a flexible pad which is engaged to an outer surface of the cap and is equipped with an upwardly protruded protrusion.

The ventilation hole has a lower side getting narrower and an upper side getting wider, so when air is discharged from a lower side to an upper side, an air discharge pressure can increase.

The ventilation hole is formed in a shape arched from a clockwise direction to a counterclockwise direction, so air is discharged in a whirlwind shape.

The pad is made of rubber or silicon material and is formed in a donut shape.

In the present invention, it is possible to effectively prevent a bedsore of a patient in such a manner that an air circulation is facilitated after a back portion of a patient is spaced apart from a mattress with the help of a moving up and down operation of an air cylinder apparatus for thereby enhancing a blood circulation.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a bedsore prevention mattress according to the present invention;

FIG. 2 is a cross sectional view illustrating a bedsore prevention mattress according to the present invention; and

FIG. 3 is a view illustrating a bedsore prevention mattress according to another embodiment of the present invention.

### DETAILED DESCRIPTION OF THE PRESENT INVENTION

The preferred embodiments of the present invention will be described with reference to the accompanying drawings.

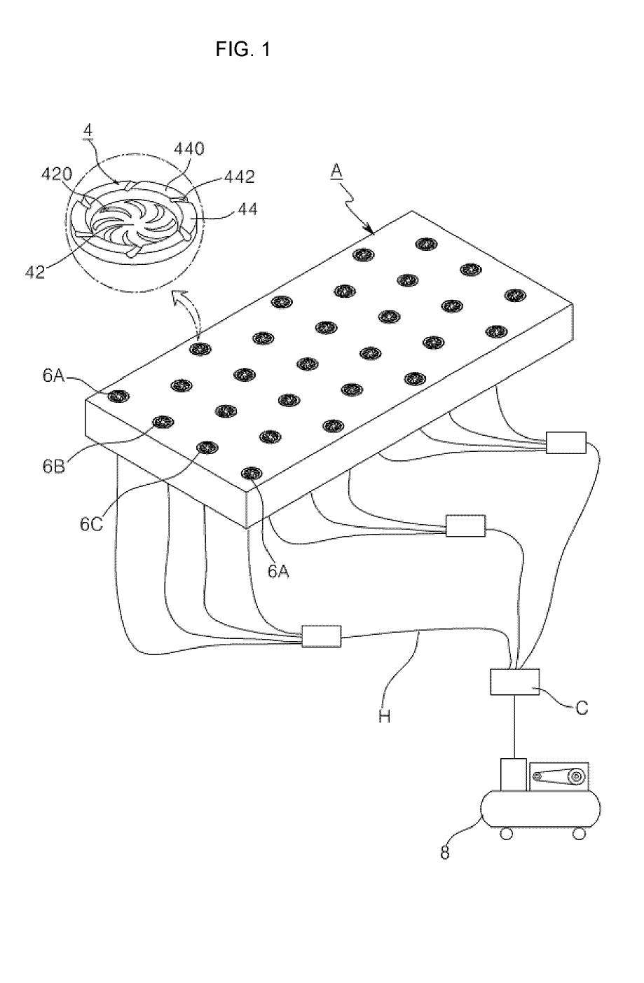

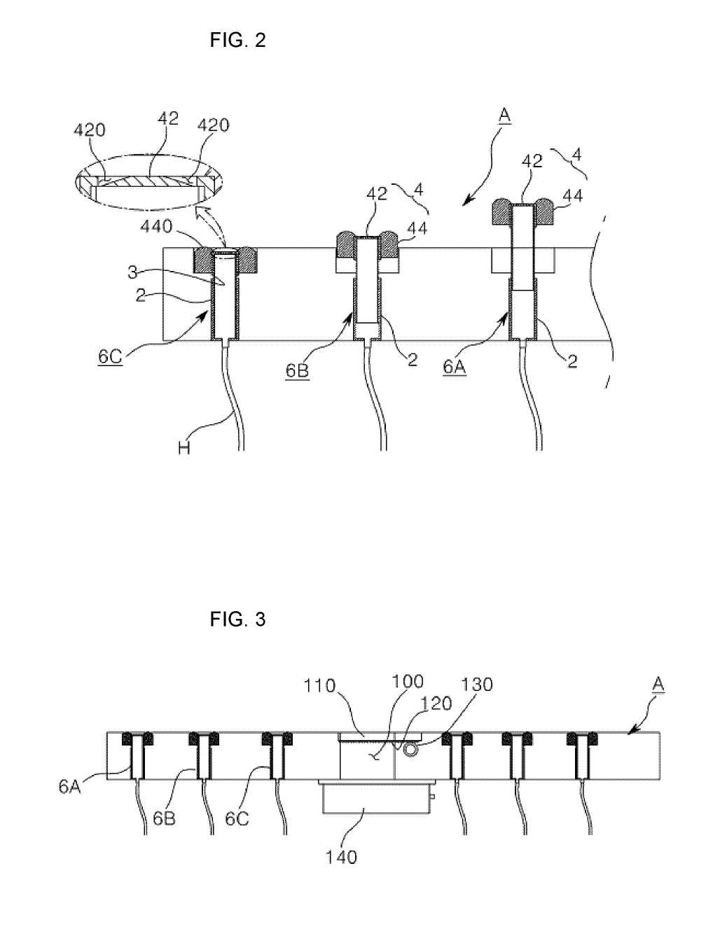

FIG. 1 is a perspective view illustrating a bedsore prevention mattress according to the present invention, and FIG. 2 is a cross sectional view illustrating a bedsore prevention mattress according to the present invention.

The bedsore prevention mattress comprises a plurality of air cylinder apparatuses 6 each equipped with a vertically installed cylinder body 2, a piston rod 3 which is engaged to each cylinder body 2 and moves up and down, and a contact member 4 which is engaged to an upper side of the piston rod 3 and contacts with a patient's back; an air supply apparatus 8 for supplying a high pressure air to each air cylinder apparatus 6; an air supply tube H which connects each air cylinder apparatus 6 and the air supply apparatus 8; and a control unit C which controls the operations of the air supply apparatus 8 and the air cylinder apparatus 6.

The mattress A is formed in a rectangular shape and is equipped with a plurality of springs for thereby producing cushion effects.

The air cylinder apparatus 6 is installed in the interior of the mattress A, with a piston rod 3 moving up and down with the help of air supply, and a contact member 4 attached to the same can contact with a patient body or can separate from the same.

The air cylinder apparatuses 6 are provided in multiple numbers, and the multiple air cylinder apparatuses 6 are grouped in at least one set. Preferably three sets of the air cylinder apparatuses 6 are provided in the present invention. In the descriptions of the present invention, three sets of the air cylinder apparatuses are given reference numbers of 6A˜6C, respectively.

The air cylinder apparatuses 6A˜6C might be arranged by one row in a straight direction along an X-axis direction or a Y-axis direction or might be arranged randomly.

The air cylinder apparatuses 6A˜6C can be configured to move up by the set in a sequence from the set A to the set C or can be configured to operate randomly.

As shown in FIG. 2, when the air cylinder apparatus 6A of the first set finishes the move up operation, the air cylinder apparatus 6B of the second set stays at the intermediate position, and the air cylinder apparatus 6C of the third set is ready before moving up, so that the first through third sets are alternately operated.

The air cylinder apparatus 6 comprises a vertically installed cylinder body 2, a piston rod 3 which moves up and down being engaged with the cylinder body 2, and a contact member 4 which is engaged to the upper side of the piston rod 3 and contacts with a patient's back.

The cylinder body 2 is cylindrically formed, of which a lower side is connected with an air supply tube H for a communication with the air supply apparatus 8, and an upper side is equipped with an open hole.

The piston rod 3 is a hollow cylindrical body which is inserted through the open hole formed in the upper side of the cylinder body 2.

The contact member 4 comprises a cap 42 which is engaged to the upper side of the piston rod 3 and is equipped with a plurality of ventilation holes 420, and a flexible pad 44 which is engaged to an outer surface of the cap 42 and is equipped with an upwardly protruded protrusion 440.

The cap 42 is equipped with an open lower side and a flat upper side, with the open part of the lower side being fixedly engaged to the upper side of the piston rod 3, and a plurality of ventilation holes 420 are formed at the flat portion of the cap.

The ventilation holes 420 might be formed in various shapes.

As shown in FIGS. 1 and 2, the ventilation holes 420 are equipped with the lower sides getting narrower and the upper sides getting wider, so when air is discharged from the lower side to the upper side, the air discharging pressure can increase.

The ventilation holes 420 are formed in the longitudinal shapes arched in clockwise directions or counterclockwise directions, so air can be discharged generating a whirlwind.

Since the pad 44 is directly contacted with a patient's body, the pad 44 is preferably made of a smooth material such as rubber or silicon and is formed in a donut shape having a through hole in its center for thereby easily engaging with an outer surface of the cap 42.

Since the upper side of the pad 44 is protruded upwardly, so the upper side of the same is positioned higher than the flat portion of the cap 42, which leads to a first contact with the patient's body.

An arc shaped guide groove 442 is formed in the upper side of the pad 44, so air circulation can be made in a state that the pad 44 contacts with the patient's skin, and the circulating air makes a whirlwind.

The operation of the present invention will be descried with reference to the accompanying drawings.

When a control unit is turned on while a patient lies on a mattress A, the air cylinder apparatuses 6 are alternately operated from the first set through the third set of the air cylinder apparatuses.

When the air cylinder apparatus 6A of the first set is positioned at the full move up state, the air cylinder apparatus 6B of the second set is positioned at the intermediate portion, and the air cylinder apparatus 6C of the third set is ready before moving up.

With the above operation, the air circulation and blood circulation can be facilitated at a patient's back portion for thereby preventing a bedsore of a patient.

FIG. 3 is a view illustrating a bedsore prevention mattress according to another embodiment of the present invention.

As shown in FIG. 3, in another embodiment of the present invention, through holes 100 are formed by punching the portions of the mattress A, so that a patient can urinate or defecate.

The through holes 100 are equipped with covers 110 which can be opened or closed based on a slide movement.

The covers 110 can be opened or closed in a manual or automatic way.

In the manual way, the cover 110 is engaged to a rail (not shown), so it can be opened or closed by hands, and in the automatic way, as shown in FIG. 3, there are provided a rack gear 120 attached to a lower surface of the cover 110, a pinion gear 130 engaged to the rack gear 120, a driving motor (not shown) which is to rotate the pinion gear 130, and a control unit C which is equipped with switches for controlling the operation of the driving motor (not shown).

A feces container 140 is detachably engaged to the lower sides of the through holes 100, respectively, for receiving the feces.

With the above constructions, a patient can urinate or defecate on the mattress A, and the feces container 140 can be separated and washed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a mattress, a bedsore prevention mattress, comprising:
a plurality of air cylinder apparatuses (6) each equipped with a vertically installed cylinder body (2), a piston rod (3) which is engaged to each cylinder body (2) and moves up and down, and a contact means (4) which is engaged to an upper side of the piston rod (3) and contacts with a patient's back;
an air supply apparatus (8) for supplying a high pressure air to each air cylinder apparatus (6);
an air supply tube H which connects each air cylinder apparatus (6) and the air supply apparatus (8); and
a control unit C which controls the operations of the air supply apparatus 8 and the air cylinder apparatus (6).

2. The mattress of claim 1, wherein said piston rod (3) of the air cylinder apparatus (6) is formed in a hollow cylindrical shape.

3. The mattress of claim 1, wherein said contact means (4) includes a cap (42) which is engaged to an upper side of the piston rod (3) and is equipped with a plurality of ventilation holes (420), and a flexible pad (44) which is engaged to an outer surface of the cap (42) and is equipped with an upwardly protruded protrusion (440).

4. The mattress of claim 3, wherein said ventilation hole (420) has a lower side getting narrower and an upper side getting wider, so when air is discharged from a lower side to an upper side, an air discharge pressure can increase.

5. The mattress of claim 4, wherein said ventilation hole (420) is formed in a shape arched from a clockwise direction to a counterclockwise direction, so air is discharged in a whirlwind shape.

6. The mattress of claim 3, wherein said pad (44) is made of rubber or silicon and is formed in a donut shape with a through hole in its center, with its upper side being upwardly protruded.

7. The mattress of claim 1, further comprising a through hole (100) formed by punching the portions of the mattress, so that a user can urinate or defecate;
a cover (110) which is engaged to the through hole (100) for opening and closing the same; and
a feces container (140) which is engaged to a lower side of the through hole (100) for receiving feces.
